(19) United States
(12) Patent Application Publication
(10) Pub. No.: US 2015/0061549 A1
(43) Pub. Date: Mar. 5, 2015

(54) BATTERY PACK, POWER TOOL AND BATTERY CHARGER

(71) Applicant: HITACHI KOKI CO., LTD., Tokyo (JP)

(72) Inventor: Yukihiro Shima, Hitachinaka-shi (JP)

(21) Appl. No.: 14/458,505

(22) Filed: Aug. 13, 2014

(30) Foreign Application Priority Data
Aug. 30, 2013 (JP) 2013-180381

(51) Int. Cl. H02J 7/00

(52) U.S. Cl. CPC H02J 7/0031; H02J 7/007; H02J 7/0042; H02J 2007/0037; H02J 2007/004
USPC 318/139; 320/112

(57) ABSTRACT

A battery pack includes: a plus terminal and a minus terminal; a secondary battery; and a booster. The secondary battery has a rated voltage and is configured to output a battery voltage across the plus terminal and the minus terminal. A charging device and a discharging device are selectively connectable to the plus terminal and the minus terminal. The charging device charges the secondary battery. The discharging device performs a job with the battery voltage supplied from the secondary battery. The booster is configured to boost the battery voltage to a voltage greater than the rated voltage. The voltage boosted is used as a control voltage for either connecting the secondary battery to or disconnecting the secondary battery from the charging device or the discharging device.

### CROSS REFERENCE TO RELATED APPLICATION

This application claims priority from Japanese Patent Application No. 2013-180381 filed Aug. 30, 2013. The entire content of the priority application is incorporated herein by reference.

### TECHNICAL FIELD

The present invention relates to a battery pack accommodating secondary battery cells, and particularly to a battery pack having lithium-ion battery cells, a power tool provided with this battery pack, and a battery charger for charging the battery pack.

### BACKGROUND

Battery packs housing secondary batteries are commonly used as power sources for power tools. Nickel-cadmium batteries (hereinafter “NiCd batteries”) have been widely used as secondary batteries in such battery packs because of their large discharge current and their short charging time. As an example, a battery pack configured of six NiCd battery cells connected in series, with each cell capable of outputting 1.2 V, has an output of 7.2 V.

However, lithium-ion batteries have become the secondary battery of choice in recent years due to the toxicity of cadmium in NiCd batteries. Since lithium-ion batteries have a high output density, such as an output of 3.6 V per cell, a battery pack with an output of 7.2 V can be configured by connecting just two lithium-ion cells in series. Therefore, there is demand for a battery pack housing lithium-ion cells that can be used with NiCd-compatible power tools and battery chargers in their existing configurations.

If overcharge, over-discharge, or the like occurs in a lithium-ion battery, the battery may degrade or malfunction, for example. To avoid these problems, a protection IC and a field-effect transistor (FET) are provided in the battery pack. The FET is turned on at the beginning of charging or discharging, while the protection IC monitors the battery voltage outputted from each battery cell. If the battery voltage rises above a prescribed value or drops below a prescribed value, the protection IC outputs a signal for shutting off the FET, interrupting the charging/discharging path as a safety measure.

### SUMMARY

Normally, a gate voltage of about 10 V is required to turn on an FET. However, a battery pack housing two lithium-ion cells connected in series produces a battery voltage that is less than 10 V. Thus, this battery pack cannot reliably turn on the FET.

In view of the foregoing, it is an object of the present invention to provide a battery pack housing lithium-ion battery cells that is wholly compatible with a battery pack housing NiCd battery cells and that can be used with existing configurations of battery driven power tools, battery chargers, and the like designed for use with the battery pack housing NiCd battery cells.

In order to attain the above and other objects, the present invention provides a battery pack. The battery pack may include: a plus terminal and a minus terminal; a secondary battery; and a booster. The secondary battery may have a rated voltage and may be configured to output a battery voltage across the plus terminal and the minus terminal. A charging device and a discharging device may be selectively connectable to the plus terminal and the minus terminal. The charging device may charge the secondary battery. The discharging device may perform a job with the battery voltage supplied from the secondary battery. The booster may be configured to boost the battery voltage to a voltage greater than the rated voltage. The voltage boosted may be used as a control voltage for either connecting the secondary battery to or disconnecting the secondary battery from the charging device or the discharging device.

According to another aspect, the present invention provides a power tool. The power tool may include a tool body; a motor; a battery pack; and a trigger. The motor may be provided in the tool body. The battery pack may serve as a power source for the motor. The trigger may be configured to start the motor. The battery pack may include a plus terminal and a minus terminal; a secondary battery; and a booster. The plus terminal and the minus terminal may be configured to connect to the tool body. The secondary battery may have a rated voltage and may be configured to output a battery voltage across the plus terminal and the minus terminal. The motor may be driven with the battery voltage supplied from the secondary battery. The booster may be configured to boost the battery voltage to a voltage greater than the rated voltage. The voltage boosted may be used as a control voltage for either connecting the secondary battery to or disconnecting the secondary battery from the motor.

According to still another aspect, the present invention provides a battery charger. The battery charger may be configured to charge a battery pack according to the present invention. The battery charger may include: a charging circuit; a control circuit; and a power supply circuit. The charging circuit may be configured to charge the battery pack. The control circuit may be configured to control the charging circuit. The power supply circuit may be configured to generate a power supply of the control circuit.

### BRIEF DESCRIPTION OF THE DRAWINGS

The particular features and advantages of the invention as well as other objects will become apparent from the following description taken in connection with the accompanying drawings, in which:

FIG. 1 is a cross-sectional view of a battery pack according to one embodiment of the present invention;

FIG. 2 is a right side view of the battery pack in FIG. 1 showing a tool-mounting surface of the battery pack according to the embodiment;

FIG. 3 is a diagram showing an appearance of the battery pack mounted on a power tool;

FIG. 4 is a block diagram showing electrical structure of the battery pack according to the embodiment;

FIG. 5 is a block diagram showing electrical structure of a battery charger;

FIG. 6 is a block diagram showing electrical structure of the power tool;

FIG. 7 is a flowchart illustrating steps in charging and discharging operations of the battery pack according to the embodiment.

FIG. 8 is a timing chart for a charging operation executed on the battery pack according to the embodiment; and

FIG. 9 is a timing chart for a discharging operation executed on the battery pack according to the embodiment.

### DETAILED DESCRIPTION

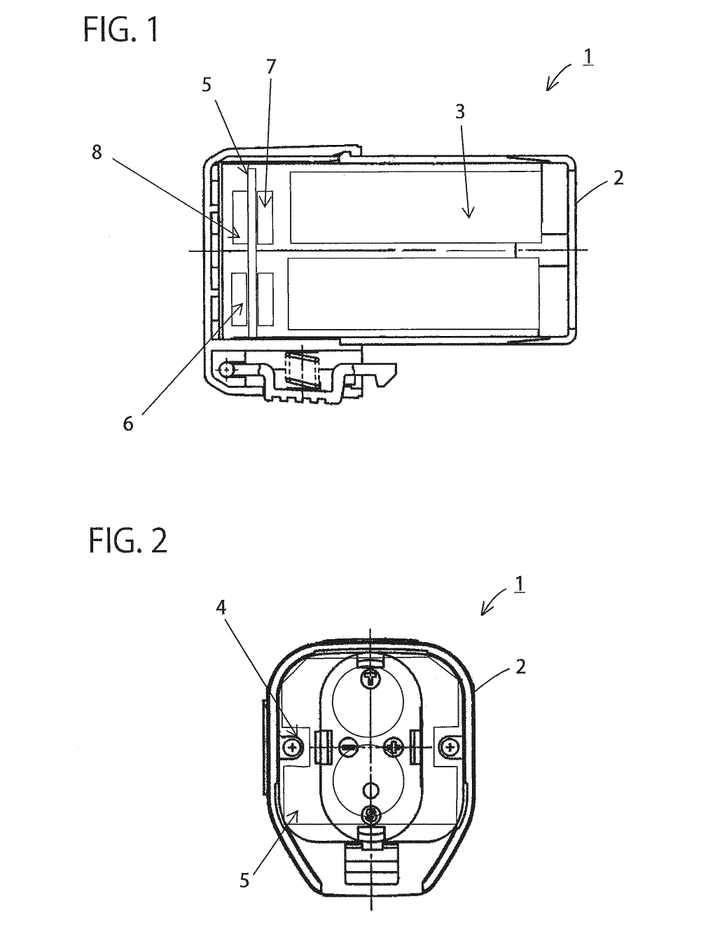

Next, a battery pack, a power tool and a battery charger according to a preferred embodiment of the present invention will be described with reference to FIGS. 1 through 9 wherein like parts and components are designated by the same reference numerals to avoid duplicating description.

FIG. 1 is a cross-sectional view of a battery pack 1 according to the embodiment. FIG. 2 is a right side view of the battery pack 1 in FIG. 1 showing a tool-mounting surface of the battery pack 1.

The battery pack 1 according to the embodiment includes a case 2, and a secondary battery 3 accommodated in the case 2. The secondary battery 3 is configured of two lithium-ion battery cells connected in series.

As shown in FIG. 2, a pair of ribs 4 is provided on inner surfaces of the case 2. The ribs 4 protrude inward from the inner surfaces. A control board 5 is provided inside the case 2 near the inner bottom surface thereof. The control board 5 is shaped to avoid the two ribs 4. On the two surfaces of the control board 5 are provided FETs 6 for charging and discharging, a protection IC 7, a microcomputer 8, and the like. In the preferred embodiment, the protection IC 7 and one of the FETs 6 are provided on the side surface of the control board 5 facing the secondary battery 3, while the microcomputer 8 and the other FET 6 are provided on the opposite side surface of the control board 5 from the secondary battery 3.

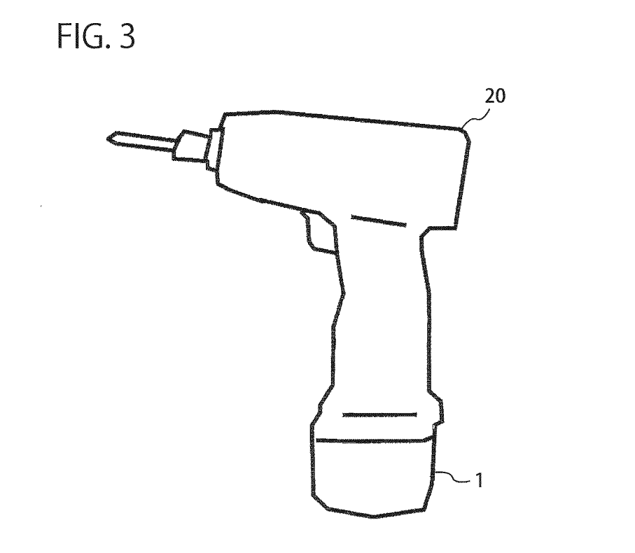

FIG. 3 shows the appearance of the battery pack 1 mounted on a power tool. The battery pack 1 is mounted on a power tool 20 in this example such that the tool-mounting surface is connected to the bottom surface of the power tool 20.

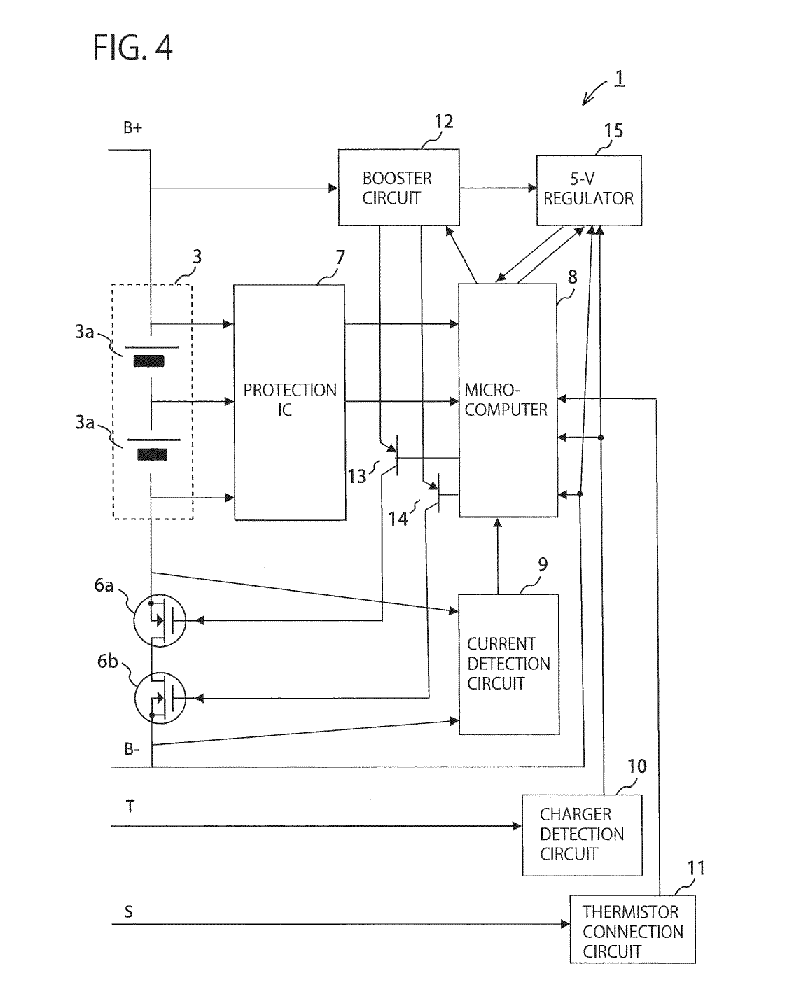

Next, the electrical structure of the battery pack 1 will be described. FIG. 4 is a block diagram showing the electrical structure of the battery pack 1 according to the preferred embodiment.

As shown in FIG. 4, the battery pack 1 includes a plus terminal B+, a minus terminal B−, a charger-connecting terminal T, and a thermistor-connecting terminal S. When using the battery pack 1 to power the power tool 20, the plus terminal B+ and minus terminal B− are respectively connected to corresponding plus and minus terminals on the power tool 20. When charging the battery pack 1 with a battery charger, the plus terminal B+ and minus terminal B− of the battery pack 1 are respectively connected to corresponding plus and minus terminals on the battery charger, and the charger-connecting terminal T and thermistor-connecting terminal S are respectively connected to a corresponding battery-connecting terminal and thermistor-connecting terminal on the battery charger. Note that electric current flows from the plus terminal B+ of the battery pack 1 to the minus terminal B− of the battery pack 1 through the power tool 20 when the battery pack 1 is used to power the power tool 20, but flows in the opposite direction when the battery pack 1 is being charged by the battery charger.

The FETs 6 are a discharge FET 6a and a charge FET 6b. As shown in FIG. 4, the secondary battery 3, discharge FET 6a, and charge FET 6b are connected in series between the plus terminal B+ and minus terminal B− of the battery pack 1.

The secondary battery 3 is configured of two lithium-ion cells 3a connected in series. The lithium-ion cells 3a output 3.6 V per cell. Hence, the rated voltage of the secondary battery 3 is 7.2 V.

The discharge FET 6a is connected to the negative side of the secondary battery 3 and functions as a discharging switch element for interrupting electric current outputted from the secondary battery 3. The charge FET 6b is connected between the discharge FET 6a and the minus terminal B− of the battery pack 1 and functions as a charging switch element for interrupting electric current inputted into the secondary battery 3.

In addition to the protection IC 7 and microcomputer 8 mentioned earlier, the battery pack 1 also houses a current detection circuit 9, a charger detection circuit 10, a thermistor connection circuit 11, a booster circuit 12, transistors 13 and 14, and a 5-V regulator 15.

The protection IC 7 is an example of a monitor of the present invention. The protection IC 7 is connected to the secondary battery 3 and monitors the battery voltage of each lithium-ion cell 3a. If the battery voltage of either cell rises to a first threshold value or higher, the protection IC 7 outputs an overcharge signal to halt the operation for charging the secondary battery 3 in order to prevent overcharging. Similarly, if the battery voltage of either cell drops to a second threshold value or lower, the protection IC 7 outputs an over-discharge signal to halt the discharging operation of the secondary battery 3 in order to prevent over-discharge. The overcharge signal and over-discharge signal outputted by the protection IC 7 are inputted into the microcomputer 8.

The current detection circuit 9 measures the voltage across the discharge FET 6a and charge FET 6b and detects the charge current flowing to the secondary battery 3 or the discharge current flowing from the secondary battery 3 based on the measured voltage. That is, the current detection circuit 9 outputs a signal proportional to the current. The current detection circuit 9 outputs a zero signal when there is no electric current, and the outputted .zero signal is inputted into the microcomputer 8.

The microcomputer 8 is an example of a discharger-detector and a tool-detector of the present invention. When the battery pack 1 is connected to the power tool 20 and a trigger 22 described later is moved to an ON position, the voltage of the secondary battery 3 is applied to the minus terminal B− through the trigger 22 and a motor 21 described later. The voltage (start-up signal) applied to the minus terminal B-is inputted into the 5-V regulator 15 and starts up the 5-V regulator 15. When the 5-V regulator 15 is started, the 5-V regulator 15 generates a control voltage for the microcomputer 8, whereby the microcomputer 8 is activated. The voltage (start-up signal) applied to the minus terminal B− is inputted into the 5-V regulator 15, as well as the activated microcomputer 8, whereby the microcomputer 8 detects that the power tool 20 has been started.

The charger detection circuit 10 is an example of a charger-detector of the present invention. The charger detection circuit 10 detects when a battery charger has been connected based on a connection signal that the battery charger inputs through the charger-connecting terminal T. Upon detecting that a battery charger has been connected, the charger detection circuit 10 starts the 5-V regulator 15 and transmits the connection signal to the microcomputer 8.

The thermistor connection circuit 11 is connected to a thermistor (not shown) provided near the secondary battery 3 of the battery pack 1. When the thermistor inputs a temperature signal into the thermistor connection circuit 11 indicating the temperature of the secondary battery 3, the thermistor connection circuit 11 transmits the temperature signal to the microcomputer 8. The thermistor connection circuit 11 also inputs the temperature signal into the charger through the thermistor-connecting terminal S.

The booster circuit 12 is an example of a booster of the present invention. The booster circuit 12 is connected to the discharge FET 6a via the transistor 13 and to the charge FET 6b via the transistor 14. When the start-up signal indicating that the power tool 20 has been started is inputted into the microcomputer 8 or when the charger detection circuit 10 inputs a connection signal indicating that a battery charger has been connected into the microcomputer 8, the microcomputer 8 outputs a boost signal to the booster circuit 12, turning the transistors 13 and 14 on. The booster circuit 12 boosts the battery voltage of the secondary battery 3 under control of the microcomputer 8 and outputs the boosted voltage as a control voltage. In the preferred embodiment, the booster circuit 12 boosts the battery voltage to 12 V. The gate voltage capable of turning on the discharge FET 61 and charge FET 6b is approximately 10 V. The control voltage outputted by the booster circuit 12 is applied to the discharge FET 6a via the transistor 13 for turning on the discharge FET 6a. The control voltage is also applied to the charge FET 6b via the transistor 14 for turning on the charge FET 6b. The booster circuit 12 also outputs the battery voltage of the secondary battery 3 unchanged (without boosting). This outputs voltage is inputted into the 5-V regulator 15. Note that it is also possible to boost the battery voltage inputted into the 5-V regulator 15.

The 5-V regulator 15 is connected to the minus terminal B−, the charger detection circuit 10, the booster circuit 12, and the microcomputer 8 and generates control power for the microcomputer 8. The 5-V regulator 15 is started by the start-up signal of the power tool 20 or a signal inputted from the charger detection circuit 10, and produces a 5-V constant voltage from the battery voltage inputted via the booster circuit 12 and applies this constant voltage to the microcomputer 8.

The transistors 13 and 14 are each connected to the microcomputer 8 and are operated under control of the microcomputer 8.

The microcomputer 8 is activated when control power is supplied from the 5-V regulator 15. When activated, the microcomputer 8 performs a prescribed process based on various input signals. The microcomputer 8 is an example of a controller of the present invention.

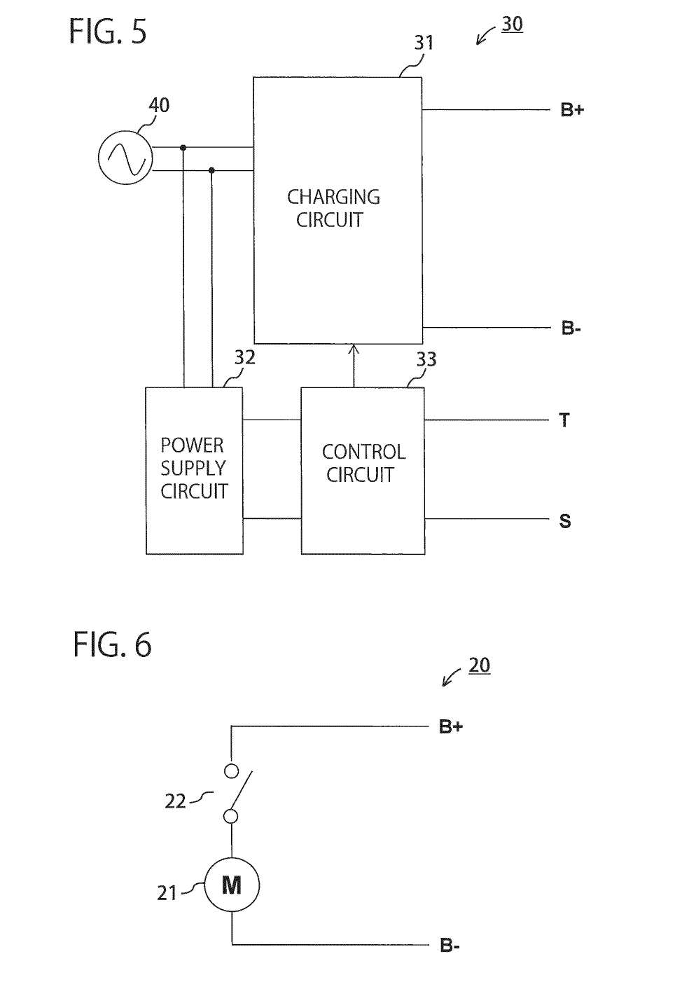

Next, the structure of a battery charger 30 connected to the battery pack 1 will be described. FIG. 5 is a block diagram showing the electrical structure of the battery charger 30.

To function, the battery charger 30 is connected to an AC power supply 40. As shown in FIG. 5, the battery charger 30 includes a plus terminal B+, a minus terminal B−, a battery-connecting terminal T, a thermistor-connecting terminal S, a charging circuit 31, a power supply circuit 32, and a control circuit 33.

The charging circuit 31 is connected to both the plus terminal B+and the minus terminal B−. The charging circuit 31 includes a rectifying and smoothing circuit, a transformer, and the like not shown in the drawings. The charging circuit 31 rectifies and smooths the AC power supplied from the AC power supply 40 and steps down the voltage using its transformer. The charging circuit 31 again rectifies and smooths the transformer output and supplies this power to the battery pack 1.

The power supply circuit 32 includes a rectifying and smoothing circuit, a transformer, a regulator, and the like not shown in the drawings. The power supply circuit 32 generates the operating voltage (5 V, for example) for the control circuit 33 using the AC power supplied from the AC power supply 40.

The control circuit 33 is connected to the battery-connecting terminal T and the thermistor-connecting terminal S. The control circuit 33 functions to determine the state of the battery pack 1 connected to the battery charger 30 based on input data from the connecting terminals, and control the charging circuit 31 according to this state. The control circuit 33 also inputs a connection signal to the battery pack 1 via the battery-connecting terminal T when the battery pack 1 is connected. Further, the control circuit 33 outputs a re-start-up signal in order to restart the 5-V regulator 15 of the battery pack 1.

Next, the configuration of the power tool 20 connected to the battery pack 1 will be described. FIG. 6 is a block diagram showing the electrical structure of the power tool 20.

As shown in FIG. 6, the power tool 20 includes a plus terminal B+, a minus terminal B−, a motor 21, and a trigger 22.

When the trigger 22 is switched on while the power tool 20 is connected to the battery pack 1, the battery voltage of the battery pack 1 applied to the plus terminal B+ of the power tool 20 is supplied to the minus terminal B− of the battery pack 1 via the trigger 22, motor 21, and minus terminal B− of the power tool 20. The microcomputer 8 of the battery pack 1 detects that the power tool 20 has started when a voltage, i.e., the start-up signal, is applied to the minus terminal B− of the battery pack 1.

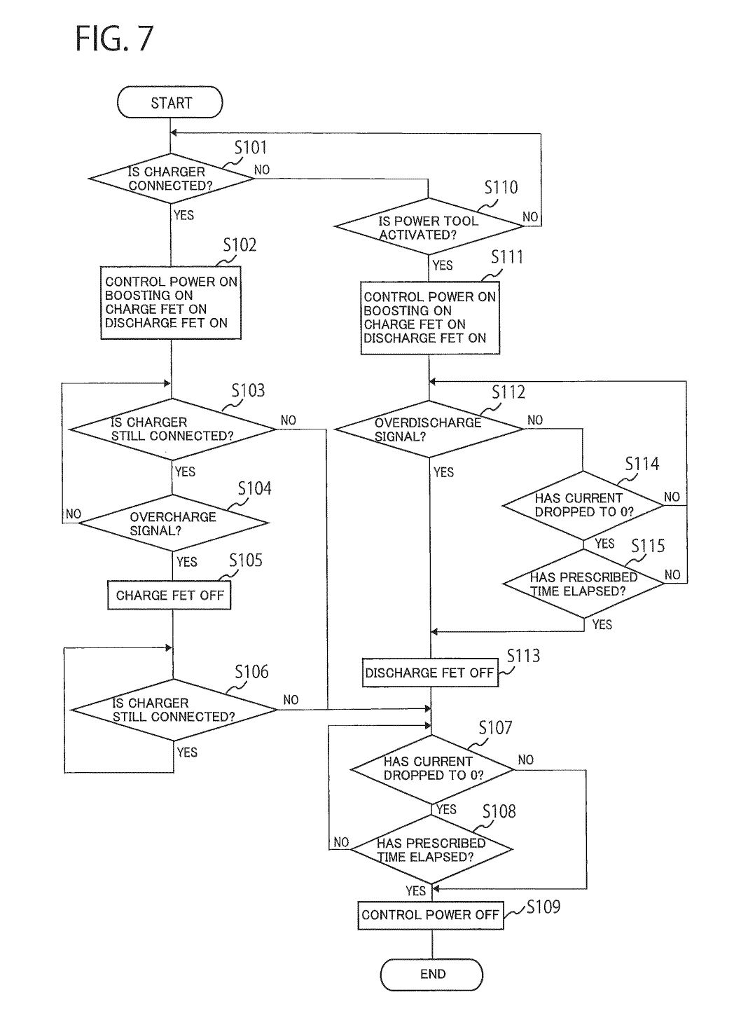

Next, the operations of the battery pack 1 having the above construction will be described. FIG. 7 is a flowchart illustrating steps in the charging and discharging operations of the battery pack 1 according to the embodiment.

First, the charging process for charging the secondary battery 3 when the battery pack 1 is connected to the battery charger 30 will be described.

When the battery pack 1 is connected to the battery charger 30, the battery charger 30 inputs a connection signal into the charger-connecting terminal T of the battery pack 1. From this connection signal, the charger detection circuit 10 of the battery pack 1 detects that the battery charger 30 has been connected. Upon detecting the connection of the battery charger 30 (S101: YES), the charger detection circuit 10 outputs a signal for starting up the 5-V regulator 15 and transmits the connection signal to the microcomputer 8.

In S102 the 5-V regulator 15 starts up in response to the signal outputted from the charger detection circuit 10 and begins generating control power that is supplied to the microcomputer 8. The microcomputer 8 starts up in response to the power supplied from the 5-V regulator 15 and begins controlling various components of the battery pack 1. Specifically, in S102 the booster circuit 12 begins boosting the battery voltage under control of the microcomputer 8. The booster circuit 12 outputs the boosted voltage as a control voltage. In addition, the microcomputer 8 turns on the transistors 13 and 14, allowing the control voltage outputted from the booster circuit 12 to be applied to the discharge FET 6a and charge FET 6b. The control voltage turns on the discharge FET 6a and charge FET 6b in S102 and the battery charger 30 begins charging the secondary battery 3.

While the secondary battery 3 is being charged, the charger detection circuit 10 continues to detect whether the battery charger 30 is still connected to the battery pack 1 in S103, and the protection IC 7 monitors the battery voltage of each lithium-ion cell 3a in S104 while the battery charger 30 is still connected (S103: YES). If the battery voltage at either lithium-ion cell 3a reaches the first threshold value, the protection IC 7 outputs an overcharge signal to the microcomputer 8 (S104: YES).

When the protection IC 7 inputs an overcharge signal into the microcomputer 8, the microcomputer 8 switches off the transistor 14 to halt charging of the secondary battery 3 in S105. Switching off the transistor 14 interrupts the control voltage being applied to the charge FET 6b, thereby turning off the charge FET 6b.

Once a connection signal is no longer being inputted from the charger-connecting terminal T, the charger detection circuit 10 and microcomputer 8 detect in S103 and S106 that the battery charger 30 has been disconnected from the battery pack 1 (S103: NO, S106: NO).

After the battery charger 30 is disconnected, the current detection circuit 9 detects that the current flowing through the discharge FET 6a and charge FET 6b has dropped to zero (S017: YES) and outputs a zero signal to the microcomputer 8. At this time, the microcomputer 8 begins measuring the duration of the zero current while determining in S108 whether a prescribed time has elapsed. When the prescribed time has elapsed (S108: YES), in S109 the microcomputer 8 controls the 5-V regulator 15 to shut off the supply of control power. The charging process ends at this time.

If the current detection circuit 9 detects an electric current flowing through the discharge FET 6a and charge FET 6b even after the battery charger 30 has been disconnected (S107: NO), the microcomputer 8 determines that an abnormality has occurred in the charging path, and in S109 immediately halts the control supply (the 5-V regulator 15) to end the charging process. The battery pack 1 may be provided with notifying means, such as an LED for indicating abnormalities, in order to notify the user of the abnormal state.

As described above, the booster circuit 12 produces a control voltage by boosting the battery voltage of the secondary battery 3 to a voltage greater than a rated voltage, thereby turning on the FETs 6, regardless of the magnitude of the battery voltage. Further, the booster circuit 12 stops boosting the battery voltage once a prescribed time has elapsed after the charging current has dropped to zero.

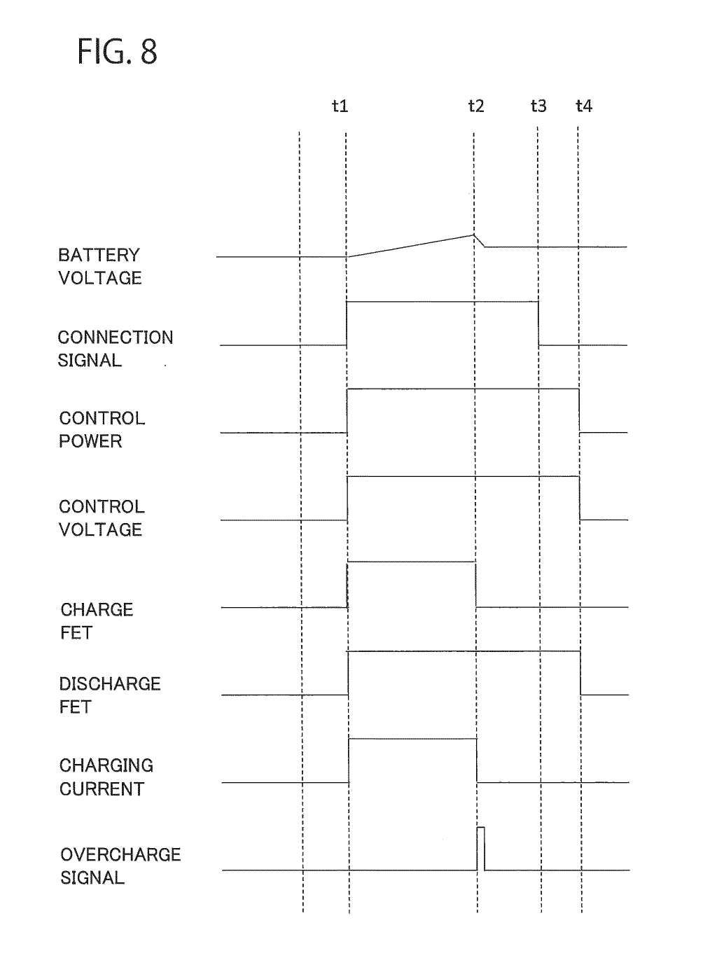

FIG. 8 is a timing chart for a charging operation executed on the battery pack 1 according to the embodiment. When the battery pack 1 is connected to the battery charger 30, the battery charger 30 inputs a connection signal via the charger-connecting terminal T at a timing t1. In response to this connection signal, the control power (the5-V regulator 15) is turned on and the booster circuit 12 begins boosting the voltage outputted from the secondary battery 3. A control voltage generated by boosting the battery voltage is applied to the discharge FET 6a and charge FET 6b under control of the microcomputer 8, turning the discharge FET 6a and charge FET 6b on. Through this action, a charging current begins flowing between the minus terminal B-and plus terminal B+, enabling the battery charger 30 to begin charging the secondary battery 3.

If the battery voltage at any of the lithium-ion cells 3a reaches the first threshold value while the battery charger 30 is charging the secondary battery 3, the protection IC 7 outputs an overcharge signal (timing t2). The microcomputer 8 halts application of the control voltage to the charge FET 6b upon receiving the overcharge signal, turning off the charge FET 6b. Consequently, the charging current drops to zero.

When the battery pack 1 is disconnected from the battery charger 30, input of the connection signal stops (timing t3). If the charging current remains at zero current for a prescribed time after the connection signal is interrupted, the microcomputer 8 controls the booster circuit 12 to stop boosting the battery voltage and turns off the control power (the 5-V regulator 15; timing t4). Through this action, the control voltage applies to the discharge FET 6a is also interrupted, turning off the discharge FET 6a.

As described above, the battery voltage is boosted while a connection signal is being inputted so that the discharge FET 6a and charge FET 6b are both turned on. The microcomputer 8 turns off the control power and halts boosting of the battery voltage after the battery charger 30 is detached from the battery pack 1, provided that the charging current remains at zero for a prescribed time.

Next, steps in the discharging process performed by the battery pack 1 when the power tool 20 is connected to the battery pack 1 and started up will be described with reference to FIG. 7.

When the power tool 20 is connected to the plus terminal B+ and minus terminal B− of the battery pack 1 and the trigger 22 of the power tool 20 is moved to its ON position, the voltage of the secondary battery 3 applied to the plus terminal B+ of the battery pack 1 causes electric current to flow between the plus terminal B+ and minus terminal B− of the power tool 20, thereby activating the power tool 20 (S110: YES). Consequently, voltage is also applied to the minus terminal B− of the battery pack 1.

When the voltage applied to the minus terminal B−, i.e., the start-up signal, is inputted into the 5-V regulator 15, starting up the 5-V regulator 15, in S111 the 5-V regulator 15 produces a control power and supplies this control power to the microcomputer 8. From the control power, the microcomputer 8 starts up and begins controlling components of the battery pack 1. When a start-up signal is inputted into the microcomputer 8, the microcomputer 8 inputs a boost signal into the booster circuit 12, whereby the booster circuit 12 begins boosting the battery voltage from the secondary battery 3 and outputs the boosted voltage as a control voltage. The microcomputer 8 turns on the transistors 13 and 14 so that the control voltage outputted from the booster circuit 12 is applied to the discharge FET 6a and charge FET 6b, turning the discharge FET 6a and charge FET 6b on. As a result, the battery pack 1 begins supplying power to the power tool 20.

While the secondary battery 3 is discharging, the protection IC 7 monitors the battery voltage at each lithium-ion cell 3a. If the battery voltage at any lithium-ion cell 3a drops to the second threshold value, the protection IC 7 outputs an over-discharge signal to the microcomputer 8.

Upon receiving an over-discharge signal (S112: YES), in S113 the microcomputer 8 turns off the transistor 13 in order to halt discharge from the secondary battery 3. Consequently, the control voltage is no longer applied to the discharge FET 6a, turning off the discharge FET 6a.

Next, the microcomputer 8 determines in S107 whether a zero signal indicating that the current detection circuit 9 detected zero current flowing between the discharge FET 6a and charge FET 6b has been inputted from the current detection circuit 9, and waits in S108 for a prescribed time to elapse. If the prescribed time elapses (S108: YES) while zero signal is still being inputted (S107: YES), in S109 the microcomputer 8 controls the 5-V regulator 15 to shut off the supply of control power. The discharging process ends at this time.

However, if the trigger 22 of the power tool 20 is returned to the OFF position after discharging has begun and before the battery voltage of any lithium-ion cell 3a has dropped to the second threshold value (i.e., before the protection IC 7 outputs an over-discharge signal; S112: NO), the battery pack 1 halts the supply of power to the power tool 20. Accordingly, if the current detection circuit 9 detects zero current flowing between the discharge FET 6a and charge FET 6b (S114: YES), the current detection circuit 9 inputs a zero signal into the microcomputer 8. Upon receiving this zero signal, the microcomputer 8 begins measuring the duration of the zero current while determining in S115 whether a prescribed time has elapsed. When the prescribed time has elapsed (S115: YES), in S113 the microcomputer 8 turns off the transistor 13, halting the application of the control voltage to the discharge FET 6a and, hence, turning off the discharge FET 6a. However, if the trigger 22 of the power tool 20 remains on (S114: NO) before the protection IC 7 outputs an over-discharge signal (S112: NO), the microcomputer 8 continues normal operations.

If the prescribed time elapses after the discharge FET 6a has been turned off in S113 (S108: YES) while the current detection circuit 9 continues to detect zero current (S107: YES), in S109 the microcomputer 8 controls the 5-V regulator 15 to shut off the supply of control power. The discharging process ends at this time.

If a current continues to flow between the discharge FET 6a and charge FET 6b even after the discharge FET 6a has been shut off (S107: NO), in S109 the microcomputer 8 determines that an abnormality has occurred in the discharging path, and halts the control supply (the 5-V regulator 15) to end the discharging process.

As described above, when the battery pack 1 is mounted on the power tool 20 and the power tool 20 is started up, the booster circuit 12 generates a control voltage by boosting the battery voltage of the secondary battery 3 to a voltage greater than a rated voltage, thereby turning on the FETs 6, regardless of the magnitude of the battery voltage. Further, the booster circuit 12 stops boosting the battery voltage once a prescribed time has elapsed after the discharging current has dropped to zero.

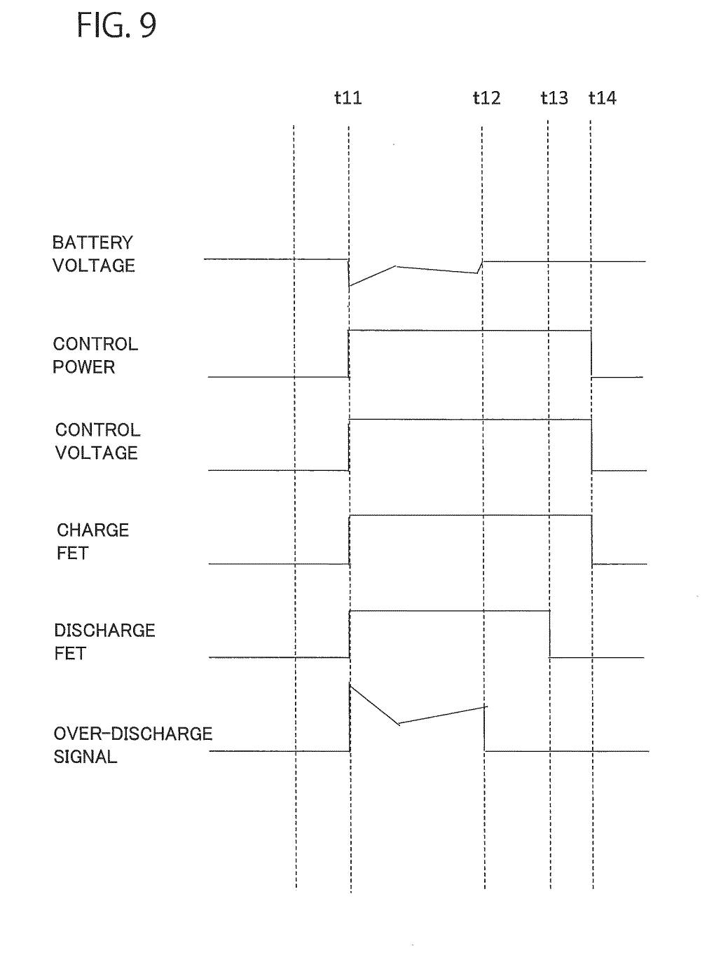

FIG. 9 is a timing chart for a discharging operation executed on the battery pack 1 according to the embodiment. When the battery pack 1 is mounted on the power tool 20 and the trigger 22 of the power tool 20 is turned on (timing t11), the power tool 20 starts up, triggering the microcomputer 8 to turn on the control power and control the booster circuit 12 to begin boosting the battery voltage. Under control of the microcomputer 8, the control voltage produced by boosting the battery voltage is applied to the discharge FET 6a and charge FET 6b, turning the discharge FET 6a and charge FET 6b on. Through this action, a discharging current begins flowing from the secondary battery 3, enabling the battery pack 1 to begin supplying power to the power tool 20. Note that the drop in battery voltage occurring immediately after the trigger 22 is switched on is caused by a momentary large discharge current (start-up current) generated when the motor 21 is started up.

As the operation continues, the battery voltage drops gradually. The discharging current from the secondary battery 3 drops to zero at a timing t12 when the battery voltage of at least one lithium-ion cell 3a drops to the second threshold value, causing the protection IC 7 to output an over-discharge signal, or when the trigger 22 of the power tool 20 is switched off. If the discharging current remains at zero current for a prescribed time, the microcomputer 8 halts application of the control voltage to the discharge FET 6a, shutting off the discharge FET 6a (timing t13).

If the discharging current remains at zero current for a prescribed time after the discharge FET 6a was turned off, the microcomputer 8 controls the booster circuit 12 to stop boosting the battery voltage and turns off the control power (timing t14). Through this action, the control voltage applied to the charge FET 6b is also interrupted, turning off the charge FET 6b.

As described above, the microcomputer 8 boosts the battery voltage upon detecting that the power tool 20 is activated, thereby turning on the discharge FET 6a and charge FET 6b. Further, if the discharging current remains at zero current for a prescribed time, the microcomputer 8 turns off the control power and stops boosting the battery voltage.

As explained above, the booster circuit 12 is housed in the battery pack 1 according to the preferred embodiment. Accordingly, the booster circuit 12 produces a control voltage by boosting the battery voltage, thereby reliably turning on the FETs 6 even when the control voltage of the FETs 6 is greater than the battery voltage (output voltage) of the secondary battery 3, enabling the charging/discharging process to begin. Hence, it is possible to provide a battery pack housing lithium-ion batteries that is completely compatible with a battery pack having a secondary battery configured of six NiCd battery cells connected in series. This lithium-ion battery pack can be used with NiCd-compatible power tools and battery chargers in their existing configuration.

Further, the battery pack 1 according to the preferred embodiment begins boosting the battery voltage after a battery charger 30 is connected to the battery pack 1 or a power tool 20 connected to the battery pack 1 is activated, and halts boosting of the battery voltage once a prescribed time has elapsed after the charging/discharging current has been shut off, thereby suppressing power consumption. Furthermore, by efficiently arranging the control parts in the battery pack 1 to avoid increasing the size of the battery pack 1, it is possible to produce a lithium-ion battery pack of approximately the same size as existing NiCd battery packs, enabling the lithium-ion battery pack to be connected to existing battery driven power tools and battery chargers.

While the invention has been described in detail with reference to the preferred embodiment, it would be apparent to those skilled in the art hat various changes and modifications may be made therein without departing from the spirit of the invention.

Note that FETs need not be housed in the battery pack 1 if the discharge FET 6a and charge FET 6b are included in the existing power tool or battery charger. For example, if the discharge FET 6a is disposed in the power tool 20, the battery pack 1 may be provided with an FET control element that is configured to apply the voltage boosted by the booster circuit 12 to the gate of the discharge FET 6a in the power tool 20 when the transistor 13 is turned on by a signal from the microcomputer 8.

What is claimed is:

1. A battery pack comprising:
a plus terminal and a minus terminal;
a secondary battery having a rated voltage and configured to output a battery voltage across the plus terminal and the minus terminal, a charging device and a discharging device being selectively connectable to the plus terminal and the minus terminal, the charging device charging the secondary battery, the discharging device performing a job with the battery voltage supplied from the secondary battery; and
a booster configured to boost the battery voltage to a voltage greater than the rated voltage, the voltage boosted being used as a control voltage for either connecting the secondary battery to or disconnecting the secondary battery from the charging device or the discharging device.

2. The battery pack according to claim 1, wherein the control voltage is applied to a switch element provided in the charging device or the discharging device whichever is connected to the plus terminal and the minus terminal.

3. The battery pack according to claim 1, further comprising a switch element applied with the control voltage and being connected to the secondary battery in series between the plus terminal and the minus terminal.

4. The battery pack according to claim 2, further comprising:
charger-detector configured to detect connection of the charging device to the plus terminal and the minus terminal; and
a controller configured to control the booster to generate the control voltage and apply the control voltage to the switch element for turning on the switch element to thereby establish connection of the charging device to the plus terminal and the minus terminal.

5. The battery pack according to claim 3, further comprising:
charger-detector configured to detect connection of the charging device to the plus terminal and the minus terminal; and
a controller configured to control the booster to generate the control voltage and apply the control voltage to the switch element for turning on the switch element to thereby establish connection of the charging device to the plus terminal and the minus terminal.

6. The battery pack according to claim 4, further comprising:
a connecting terminal configured to connect the charging device, the charging device outputting a connection signal to the connecting terminal when the charging device is connected to the connecting terminal,
wherein the charger-detector determines that the charging device is connected to the connecting terminal in response to the connection signal.

7. The battery pack according to claim 5, further comprising:
a connecting terminal configured to connect the charging device, the charging device outputting a connection signal to the connecting terminal when the charging device is connected to the connecting terminal,
wherein the charger-detector determines that the charging device is connected to the connecting terminal in response to the connection signal.

8. The battery pack according to claim 4, further comprising:
a monitor configured to monitor the battery voltage and output an overcharge signal when the battery voltage has reached a first threshold value,
wherein the controller halts generating the control voltage in response to the overcharge signal, thereby rendering the switch element off.

9. The battery pack according to claim 5, further comprising:
a monitor configured to monitor the battery voltage and output an overcharge signal when the battery voltage has reached a first threshold value,
wherein the controller halts generating the control voltage in response to the overcharge signal, thereby rendering the switch element off.

10. The battery pack according to claim 2, further comprising:
a discharger-detector configured to detect start-up of the discharging device connected to the plus terminal and the minus terminal; and
a controller configured to control the booster to generate the control voltage and apply the control voltage to the switch element for turning on the switch element to thereby establish connection of the discharging device to the plus terminal and the minus terminal.

11. The battery pack according to claim 3, further comprising:
a discharger-detector configured to detect start-up of the discharging device connected to the plus terminal and the minus terminal; and
a controller configured to control the booster to generate the control voltage and apply the control voltage to the switch element for turning on the switch element to thereby establish connection of the discharging device to the plus terminal and the minus terminal.

12. The battery pack according to claim 10, wherein the discharger-detector includes a current detecting circuit configured to detect a current flowing in the discharging device.

13. The battery pack according to claim 11, wherein the discharger-detector includes a current detecting circuit configured to detect a current flowing in the discharging device.

14. The battery pack according to claim 10, further comprising:
a monitor configured to monitor the battery voltage and output an over-discharge signal when the battery voltage has reached a second threshold value,
wherein the controller halts generating the control voltage in response to the over-discharge signal, thereby rendering the switch element off.

15. The battery pack according to claim 11, further comprising:
a monitor configured to monitor the battery voltage and output an over-discharge signal when the battery voltage has reached a second threshold value,
wherein the controller halts generating the control voltage in response to the over-discharge signal, thereby rendering the switch element off.

16. The battery pack according to claim 1, wherein the secondary battery comprises two lithium-ion battery cells connected in series.

17. The battery pack according to claim 1, wherein the discharging device is a battery-driven power tool.

18. A power tool comprising:
a tool body;
a motor provided in the tool body;
a battery pack serving as a power source for the motor; and
a trigger configured to start the motor,
wherein the battery pack comprises:
a plus terminal and a minus terminal configured to connect to the tool body;
a secondary battery having a rated voltage and configured to output a battery voltage across the plus terminal and the minus terminal, the motor being driven with the battery voltage supplied from the secondary battery; and
a booster configured to boost the battery voltage to a voltage greater than the rated voltage, the voltage boosted being used as a control voltage for either connecting the secondary battery to or disconnecting the secondary battery from the motor.

19. The power tool according to claim 18, further comprising a switch element,
wherein the control voltage is applied to the switch element.

20. The power tool according to claim 19, wherein the battery pack further comprises:
a tool-detector configured to detect operation of the trigger; and
a controller configured to control the booster to generate the control voltage and apply the control voltage to the switch element for turning on the switch element to thereby establish connection of the secondary battery to the motor.

21. The power tool according to claim 20, wherein the tool-detector includes a current detecting circuit configured to detect a current flowing in the motor.

22. The power tool according to claim 20, wherein the battery pack further comprises a monitor configured to monitor the battery voltage and output an over-discharge signal when the battery voltage has reached a second threshold value,
wherein the controller halts generating the control voltage in response to the over-discharge signal, thereby rendering the switch element off.

23. The power tool according to claim 18, wherein the secondary battery comprises two lithium-ion battery cells connected in series.

24. A battery charger configured to charge a battery pack according to claim 1, the battery charger comprising:
a charging circuit configured to charge the battery pack;
a control circuit configured to control the charging circuit; and
a power supply circuit configured to generate a power supply of the control circuit.
